(19) United States
(12) Patent Application Publication
(10) Pub. No.: US 2011/0194858 A1
(43) Pub. Date: Aug. 11, 2011

(54) Hot-pluggable transceiver flash memory media reader/writer, systems, methods, apparatus, networks and devices

(75) Inventors: Sergiu Rotenstein, Chatsworth, CA (US); Nye Liu, Chatsworth, CA (US)

(73) Assignee: MRV Communications, Inc.

(21) Appl. No.: 12/931,885

(22) Filed: Feb. 11, 2011

Related U.S. Application Data
(60) Provisional application No. 61/337,963, filed on Feb. 11, 2010.
(60) Provisional application No. 61/344,247, filed on Jun. 18, 2010.

(51) Int. Cl. H04B 10/00

(52) U.S. Cl. 398/135

(57) ABSTRACT

Diverse operational and functional combinations of hot pluggable transceivers, flash, and similar, media cards and other devices, networks, network portions, systems and methods, and memory card reader/writer devices and apparatus, are provided. Networks, network portions, modules, devices, apparatus and methods utilizing the numerous possible combinations of these elements, including software, and to their many advantages and embodiments, are also provided. The inventions relate also to software-enabled operational and functional systems, modules, networks, devices, apparatus and methods utilizing numerous possible combinations of software with these elements and to their many advantages and embodiments

### CLAIM OF PRIORITY

Applicants hereby claim priority to U.S. Provisional Patent Application Ser. No. 61/337,963, filed Feb. 11, 2010, and to U.S. Provisional Patent Application Ser. No. 61/344,247, filed Jun. 18, 2010, and do hereby incorporate these two applications in their entireties.

### FIELD OF THE INVENTION

The present inventions relate to the operational and functional combination of pluggable transceivers, methods and networks, with flash (and functionally similar) memory card or solid state reader/writer devices and apparatus, and to networks, modules, devices, apparatus and methods utilizing the numerous possible combinations of these elements, and to their many advantages and embodiments. The inventions relate also to software-enabled operational and functional systems, modules, networks, devices, apparatus and methods utilizing numerous possible combinations of software with these elements. Although the present technology is described herein frequently as, and with respect to “flash” and similar media, it can, with the benefit of the present application, be applied to any future compact storage technology, including any solid state digitally enabled media or devices.

Hot-pluggable transceivers are often utilized in optical fiber communications and digital data transfer systems and networks. In some preferred embodiments, the present inventions combine one or more slots or slot reader/writer adapters that operationally connect one or more flash memory cards with one or more hot-pluggable transceivers. In one simple embodiment of the present invention, a single flash memory card reader/writer is operationally connected to a single Hot-Pluggable Transceiver (HPT).

In a significant aspect of some of these combinations, the inventions provide a flash memory reader/writer in a physical form that is operationally and functionally connected to the system interface of a hot-pluggable transceiver. Among other embodiments, the present inventions include any combination of one or more hot-pluggable transceivers with any combination or number of flash-memory-card memory devices, types and numbers. The present inventions also include wherein various types of data and software are provided via the one or more hot-pluggable transceivers.

### BACKGROUND OF THE INVENTION

Conventional Hot Pluggable Transceivers (HPT's) are optical and/or other media transceivers that are pluggable, that is, they can be added or interposed into a system while the system is operational. In one key aspect, Hot-Pluggable Transceivers are typically adapted and arranged to interface a network device motherboard (for a switch, router, media converter or other such devices) to a fiber optic or copper networking cable. They can also be adapted, combined and arranged for many other purposes.

Hot Pluggable Transceivers typically utilize formats such as SFP (Small Form-factor Pluggable), XFP, XENPAK, X2 and CFP. In the context of the inventions, any format or formats which are suitable for the function to which the module will be adapted can be utilized. As an advantage of the present inventions, HPT's can also be adapted and utilized with yet other existing, or customized, formats or configurations.

In general, conventional hot-pluggable transceivers typically comply with industry standards, such as the MSA (Multi-Source Agreement) standards, and are supported by many network component vendors. Conventional Hot-Pluggable Transceivers typically support one or multiple major communication protocols (like SONET/SDH, Ethernet and Fiber Channel, and the like) and operate at speeds from few Mbps up to 10 Gbps, to 40 and even 100 Gbps. New and/or faster HPT's will likely soon be available and are adaptable to the present inventions. Conventional Hot Pluggable Transceivers are widely used in many common telecommunication and data communications systems. The evolution of Hot Pluggable Transceivers is likely to evolve in parallel with the progress of networking technologies.

Indeed, over the past years, new types of hot-pluggable transceivers have been created. As examples: GBIC was one of the first to be created followed by SFP; 10G XENPAK became available, followed by X2, by XFP and now SFP+ is commonly in use. In response to higher speed and capacity needs, the 40G and 100G industries created the CFP interface, and are expected to create more types of such Hot-Pluggable Transceivers. Advantageously, the present inventions are applicable to any type of currently available Hot Pluggable Transceivers that now exist, as well as to any that will be provided in the future.

In the conventional communications and data transfer industries, it is common for an HPT to interface with the hosting systems through a well-defined electrical interface. The electrical interface generally comprises connector pins for A) the power supply—system supplies power (VCC) to the transceiver; B) at least one ground (TX and RX)—system supplies reference ground to the transceiver Transmitter and Receiver circuitry; and C) I2C=a transceiver management bus. This slow management bus (I2C) allows provisioning and monitoring of the pluggable transceiver. Through this path, a hosting system can read the basic static transceiver information, as examples, the transceiver type, manufacturer, serial number, maximum rate, etc., as well as the dynamic running time information (as examples, the transmission power, receiver power, bias current, operational alarms, and the like). The electrical interface generally also includes connector pins for D) data transfer—differential data TX and RX; and E) other services like transmit enable or data rate select and/or error indication, for example, TX Fault, LOS, etc.

The key characteristics of exemplary hot-pluggable transceivers are outlined in Table 1. Table 1 is drawn from the SFP Multi-Source Agreement, and lists some of the con-nectivity electrical interface of SFP (Small Form Factor Pluggable) transceivers relevant to connectivity to a hosting system.

TABLE 1
Pin Function Definitions

| Pin | | | Plug | |
|---|---|---|---|---|
| Num. | Name | Function | Seq. | Notes |
| 1 | VeeT | Transmitter Ground | 1 | |
| 2 | TX Fault | Transmitter Fault | 3 | Note 1 |
| | | Indication | | |
| 3 | TX Disable | Transmitter Disable | 3 | Note 2 |
| | | | | Module disables |
| | | | | on high or open |
| 4 | MOD-DEF2 | Module Definition 2 | 3 | Note 3, 2 wire |
| | | | | serial ID interface |
| 5 | MOD-DEF1 | Module Definition 1 | 3 | Note 3, 2 wire |
| | | | | serial ID interface |
| 6 | MOD-DEF0 | Module Definition 0 | 3 | Note 3, |
| | | | | Grounded |
| | | | | in Module |
| 7 | Rate Select | Select between full or | 3 | Note 4 |
| | | reduced | | Low or Open - |
| | | receiver bandwidth | | reduced |
| | | | | bandwidth, |
| | | | | High - |
| | | | | full bandwidth |
| 8 | LOS | Loss of Signal | 3 | Note 5 |
| 9 | VeeR | Receiver Ground | 1 | Note 6 |
| 10 | VeeR | Receiver Ground | 1 | Note 6 |
| 11 | VeeR | Receiver Ground | 1 | Note 6 |
| 12 | RD− | Inv. Received Data Out | 3 | Note 7 |
| 13 | RD+ | Received Data Out | 3 | Note 7 |
| 14 | VeeR | Receiver Ground | 1 | Note 6 |
| 15 | VccR | Receiver Power | 2 | 3.3 ± 5%, |
| | | | | Note 8 |
| 16 | VccT | Transmitter Power | 2 | 3.3 ± 5%, |
| | | | | Note 8 |
| 17 | VeeT | Transmitter Ground | 1 | Note 6 |
| 18 | TD+ | Transmit Data In | 3 | Note 9 |
| 19 | TD− | Inv. Transmit Data In | 3 | Note 9 |
| 20 | VeeT | Transmitter Ground | 1 | Note 6 |

### SUMMARY OF THE INVENTION

The present inventions are especially advantageous in that they can utilize both conventional and as-yet-to-be-developed Flash Memory Cards. A Flash Memory Card (FMC) is a solid-state electronic flash memory data storage device capable of storing digital contents. Typically, conventional flash memory cards are used with digital cameras, handheld and mobile computers, mobile phones, music players, digital cinematography cameras, video game consoles, and other electronic products. Functionally, they offer high re-recordability, the virtually power-free storage of data and other digital matter, such as programs, and rugged environmental specifications. In a typical flash memory card, information is organized in a flash memory in a standard FAT32 files system format that is accessible and editable from any PC and many other devices. Both typical and atypical flash memory cards can be utilized in the context of the present invention.

### BRIEF DESCRIPTION OF THE DRAWINGS

FIG. 1 shows the overall structure of SFP-microSD that has a Hot-Pluggable Transceiver Flash Memory Card Reader/Writer.

FIG. 2 shows a USB wireless adapter.

FIG. 3 shows SFP+microSD in a Networking System Network Management (NM) Card.

FIG. 4 shows an 8-port switch+SFP-microSD+1 GB microSD (SFP interfaces). Multiple System Network Management (NM) cards interconnected to the Ethernet switch that contains the SFP-microSD-FE SFP micro-SD reader/writer with its 1 GByte micro-SD flash memory. The specific implementation of the SFP-microSD-FE offers the standard I2C interface and an in-band Fast Ethernet 100 Base-FX interface.

FIG. 5 shows an embodiment of usage of the invention in an extended network. Exemplary Network of Systems in which each System carries an Embodiment of an HPT+Flash Memory Card Module of the Inventions In this example, each system in the network (has available hot-pluggable transceiver socket) carry an instance of a Hot-Pluggable Transceiver Flash Memory Card Reader/Writer and a flash memory card. The information in the Flash Memory Card may provide the system unique functionality, may carry its provisioning as well as any security/encryption parameters, necessary to protect the system access.

FIG. 6 shows a network in which some systems carry an instance of the invention. In this example some of the network systems (that have available hot-pluggable transceiver socket) carry an instance of a Hot-Pluggable Transceiver Flash Memory Card Reader/Writer and a flash memory card. These systems serve as servers for themselves and for other systems in the network. The information in the Flash Memory Card may provide each system cluster a unique functionality, may carry its provisioning as well as any security/encryption parameters, necessary to protect the specific cluster system access (see diagram coloring).

FIG. 7 shows an example of adding WIFI/BLUETOOTH/WIMAX to an SFP-based system; included herein are SFP Processor card+SFP-USB+USB wireless adapter OR USB Bluetooth adapter.

### DETAILED DESCRIPTION OF THE INVENTION

In many preferred embodiments, the present inventions combine one or more Flash Memory cards reader/writers with at least one Hot-Pluggable Transceiver (HPT). In some preferred embodiments, the inventions comprise a flash memory reader/writer in the physical format and system interface of a hot-pluggable transceiver. The inventions include any combination of a Hot-Pluggable Transceiver with one or multiple flash-memory cards of any current or future type. Multiples of such units can be utilized to store information relevant to a carrier system, for example, and to create, update, configure, re-configure, or sequester network portions, and to otherwise improve existing or developing systems.

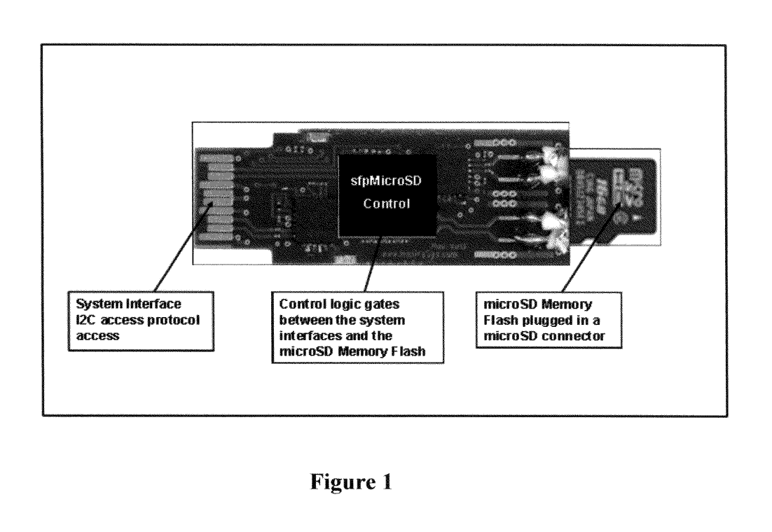

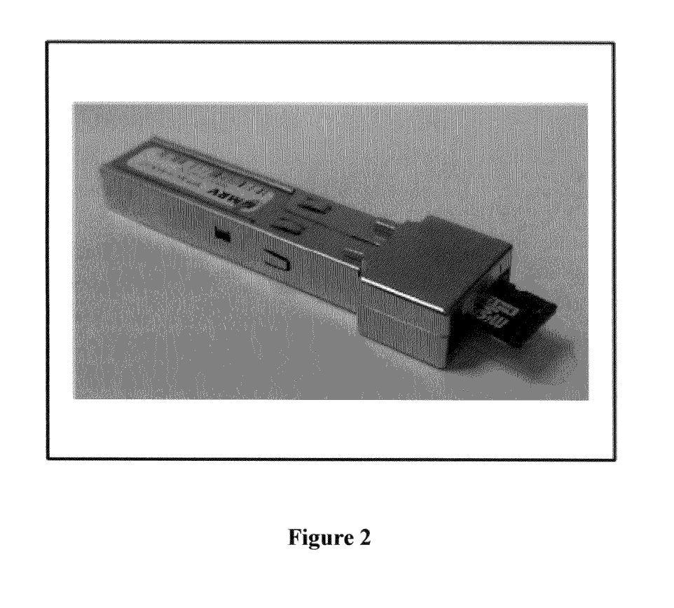

An exemplary implementation of the invention comprises a micro-SD reader/writer disposed inside an SFP (see FIG. 1 for internal architecture and FIG. 2 for a final embodiment) or an XFP Module. FIG. 1 shows an example of the internal architecture, while FIG. 2 shows an example of a final embodiment. Similarly, a larger Hot-Pluggable Transceiver, for example, a CFP or XENPAK, may accommodate a flash based solid state (flash memory based) hard-drive.

According to one aspect of the invention, a hosting system can be adapted and arranged to access one or more Hot-Pluggable Transceivers via one or more paths. Among these paths are A) the slow management bus (I2C) intended for provisioning and monitoring of the hot-pluggable transceiver; B) the data path (TX and RX) generally employed by the Hot-Pluggable Transceiver hosting system to transmit and receive protocol data to/from the networking link; and C) one or more of the special services lines for enabling activity, data rate selection or error/event monitoring.

As another advantage, the present Hot-Pluggable Transceiver flash memory card reader/writers allow read and write access to the flash-memory card through the standard HPT bus—the I2C—by means of additional I2C based registers that access the flash-memory card to effect the read and write functions. As one of skill in the art will appreciate, this is superior to using the MSA defined registers to accomplish the same goal.

In addition to the local system access method, based on the MSA I2C register bank extension, the present invention provides embodiments suitable for in-band flash-memory card access, through the one or more specific networking protocols carried by the one or more hot-pluggable transceivers. For example, such an implementation can provide flash-memory card access (read or write) by means of Ethernet packets, when one or more devices of the invention are operationally plugged into an Ethernet device, for example, an Ethernet converter, switch or router, or any computer system with a Hot-Pluggable Transceiver Ethernet interface.

In accordance with other advantages of the present invention, the in-band access implementation may vary in range and complexity. There are numerous options, combinations and permutations of the inventions. Several of the preferred embodiments of the options include, as examples, and not by way of limitation, I) a simple layer 2-based proprietary read/write access. In this example, the access may be based on a proprietary simple Ethernet layer-2 packet based read/write protocol. Advantageously, no upper layer like TCP/IP must be employed. Security aspects in a system thus equipped can be done at the overall network access level; II) standard TCP/IP protocols, such as TFTP, FTP, HTTP or similar secure protocols like HTTPS, STP, etc, may also be employed. In some preferred embodiments, data encryption may be applied before transport, and data decryption may be applied after transport. Any of these implementations may require provisioning, for example, of the TCP/IP parameters or security parameters provisioning, etc.

As additional advantageous aspects of the invention, standardized local storage and Network Attached Storage (NAS) protocols may be utilized. These include, but are not limited to, SDIO, SATA, SCSI, Firewire, and the like, over Ethernet (or other layer 1 and/or layer 2 technology, such as FC natively, and standardized network filesystem protocols (such as SMB, NFS, WebDAV etc.) over IP. As one of skill in the art will understand in this context, any protocols that are adapted and arranged to function within the context of the invention can also be utilized, not simply those limited to IP over Ethernet functionality.

As yet another advantage, a Hot-Pluggable Transceiver Flash Memory Card Reader/Writer of the invention may be adapted and arranged to operate within, or in conjunction with, a network comprising of internetworking devices, for example, Metro Ethernet Switches, as a hard-wired limiter for parameters of the provisioning range. In one aspect, the memory of the card may contain parameters like region, city, neighborhood, etc. that confines a touchless provisioning management system to allocating only certain ranges of the necessary parameters.

While these limits may be applied through the application itself, the Hot-Pluggable Transceiver Flash Memory Card Reader/Writer and its flash memory, may also play the roles of additional “hardware” security keys, to thereby instruct portions, or all, of an internetworking system, to not accept parameters outside the ranges prescribed via the HPT interface.

As yet another advantage, such changes as exemplified above, may be effected on an external system, such as a PC, by editing the flash-memory itself (by editing files residing on a microSD memory card or the like), by means of a standard PC equipped with a reader adapted to read such memories.

Examples of a few of the many implementations of the present inventions include wherein the HTP is adapted and arranged to hold system applications including, but not limited to: system software patches and DLL (dynamic link libraries); system configuration files that configure and provision the system and change its functionality or behavior; system applets for network management applications (applets served by the system); system and network wide security keys and dynamic key-regeneration algorithms. In a similar aspect, some preferred embodiments of the present inventions may include images and sounds for systems originated with respect to Java-based network management applications (applets served by the system)

In yet another key advantageous aspect, embodiments of the invention include wherein the addition of new flexible interfaces can be effected by means of the IO defined for a flash memory interface, for example, those adapted for SDIO (Secure Digital Input Output) or USB being interfaced with respect to, as examples, WIFI, Bluetooth, WIMAX, and whatever other adaptations may be desirable. These may include, as additional examples, modems, Ethernet adapters, barcode readers, IdDA adapters, RFID readers, TV tuners and digital cameras.

In many preferred embodiments of the inventions, the common pluggable transceiver I2C interface can be adapted and arranged to function as the invention control interface. Through this interface, the hosting system may, for example, i) enable/disable in-band read or write access; and ii) configure any appropriate in-band access parameters, depending on the specific in-band access implemented. As one of skill in the art will comprehend, in many preferred embodiments of the inventions, the special control and monitoring lines may be used for the implementation of specific tasks, like enabling or provisioning features or for error/event monitoring.

The devices, transceivers, systems, modules, networks, apparatus and methods of the present inventions solve an acute problem for any communications or data transfer system, whenever that the system comprises at least one Hot-Pluggable Transceiver interface. In general, such systems have a microprocessor environment equipped with certain volatile memories (RAM) and certain non-volatile memories. The non-volatile memories are, typically, flash memories. A common problem in conventional systems is that the amount of non-volatile memory available for storing the programs, system configurations, system logs, etc., becomes insufficient as system demands increase.

As these demands increase, more non-volatile memory/flash memory are required. While new overall system designs containing more non-volatile memory/flash memory are possible, they are costly and inefficient. In these circumstances, there are always problems with respect to the installed base that may require system upgrades and costly replacements, both for the vendor and for the user. Common flash sizes for typical conventional systems are 16-128 megabytes of non-volatile memory/flash memory.

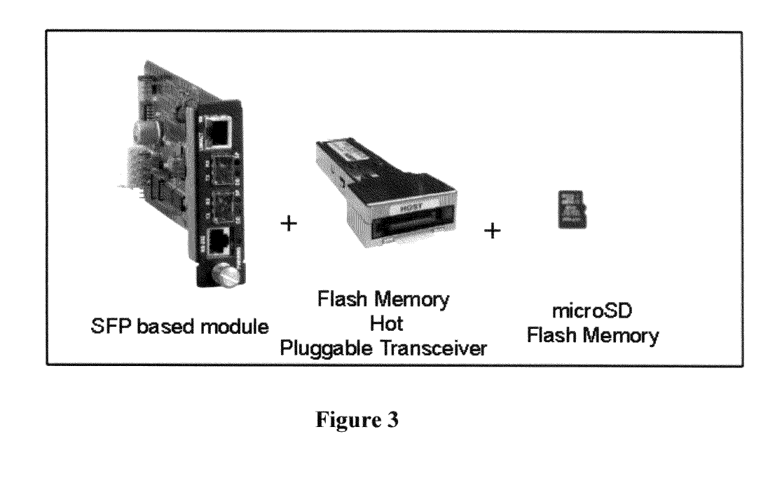

The many Hot-Pluggable Transceiver flash memory card reader/writer embodiments of the present inventions offer a direct and efficient migration path for the upgrading and re-configuration of many conventional telecommunications and data transfer systems. By using one or more of the existing Hot-Pluggable Transceiver interfaces to add very significant amounts of non-volatile/flash memory, as well as other system functional and operational upgrades, conventional systems can be upgraded and modernized multiple times as desired, in extremely advantageous manners and sequences. See FIG. 3, which shows an SFP+microSD in a Networking System Network Management (NM) Card.

As an example of one key parameter that can be improved efficiently and significantly by the current inventions, current minimum sizes for typical flash memory cards are measured in gigabytes. This is in sharp contrast to the relatively low 16-128 megabytes of non-volatile/flash memory currently embedded in conventional systems. By employing pluggable flash memory cards as in the means and methods of the current inventions, memory size evolution in line with the increased and changing systems demands can be assured, monitored and developed.

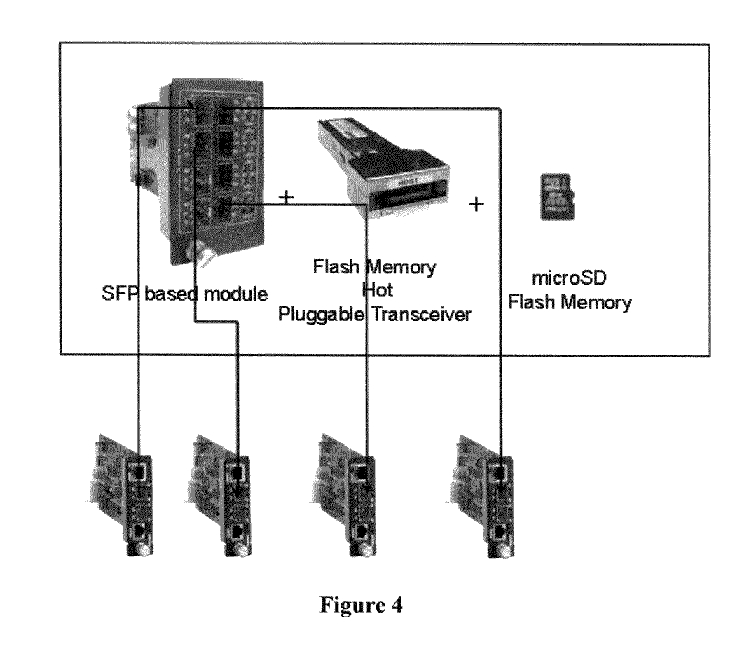

Moreover, when accessed through its in-band interfaces, the combined Hot-Pluggable Transceiver flash memory card reader/writers of the inventions allow for the easy creation of a network-based storage server, as a common resource that serves multiple systems that would otherwise starve for additional non-volatile/flash memory. FIG. 4 shows an 8-port switch+SFP-microSD+1 GB microSD (SFP interfaces. Multiple System Network Management (NM) cards interconnected to the Ethernet switch that contains the SFP-microSD-FE SFP micro-SD reader/writer with its 1 GByte micro-SD flash memory. In this embodiment, the specific implementation of the SFP-microSD-FE offers the standard I2C interface and an in-band Fast Ethernet 100 Base-FX interface.

The many combinations and permutations of embodiments of the inventions include wherein other types of memory are utilized to perform the desired functions in the context of specific uses. Among these is, as an example, RAM type of memory, which is especially useful when enabling a potentially fast in-band access interface.

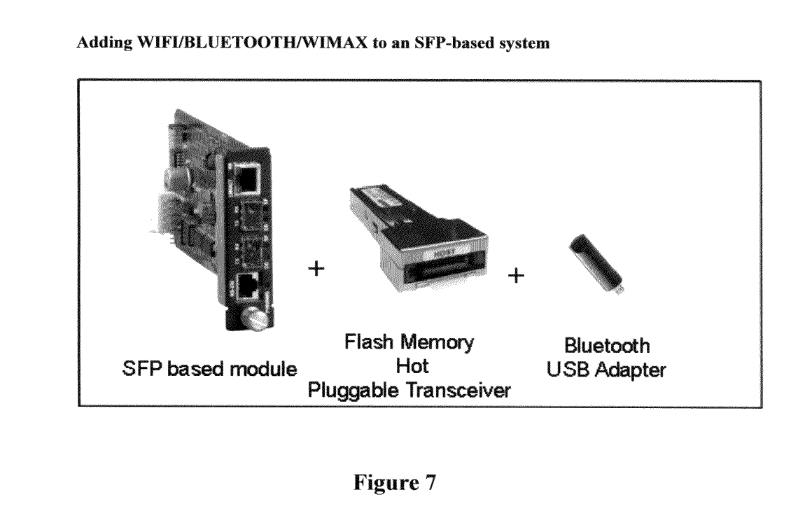

In some preferred embodiments of the inventions, for example, when employing a USB Flash Drive, the inventions advantageously create an adaptor for a USB interface to an MSA compliant Hot-Pluggable Transceiver interface. In these embodiments and others, any USB-based solution may be adapted to “plug-in” an MSA-compliant Hot-Pluggable Transceiver socket. Such embodiments of the inventions allow the creation, adaptation and arrangement of systems comprising MSA-compliant HPT sockets, to thereby expand their functionality and adaptability to the capabilities of existing and future USB solutions. FIG. 7 illustrates an example of such embodiments achieved by adding WIFI/BLUETOOTH/WIMAX to an SFP-based system. This specific embodiment includes an SFP Processor card+SFP-USB+USB wireless adapter OR USB Bluetooth adapter.

Other advantageous examples include: (a) SFP-based Fast Ethernet switches, expanded by means of HPT units to offer wireless (802.1a/b/g/n etc.) interfaces (such implementations employing, as an example, HTP's further enabled with one or more USB wireless adapters, and appropriate software drivers); (b) SFP-based Fast Ethernet switches expanded to offer Bluetooth interfaces, (these implementations can be adapted and arranged to employ the invention together with an off-the-shelf USB wireless adapter, and appropriate software drivers); and (c) SFP-based Fast Ethernet switches expanded to offer WIMAX interfaces (such implementations employing the invention together with an off-the-shelf WIMAX wireless SDIO adapter, and appropriate software drivers and the like).

In yet other preferred embodiments of the inventions, the one or more adaptors for a USB (or other) interface to an MSA compliant Hot-Pluggable Transceiver interface are adapted and arranged to include any Flash Memory Reader/Writer Interface IO expansion device, system, application, or combinations thereof. Such embodiments include, for example, interfaces such as SDIO (secure digital input/output) interfaces, and also any currently known or future Flash Memory Reader/Writer Interface IO expansion devices, systems, applications, or combinations thereof. Advantageously, these embodiments of the inventions allow the creation, adaptation and arrangement of systems comprising MSA-compliant HPT sockets, to expand their functionality and adaptability to the capabilities of existing and future Flash Memory Reader/Writer Interface IO solutions.

The following examples are provided as additional illustrations of other preferred embodiments of the invention, and are not limiting with respect to present or future media or other devices. Such exemplary illustrations include: SFP-based Fast Ethernet switches, which are adapted and arranged to be expandable to offer wireless (802.1a/b/g/n etc.), and similar interfaces. Such implementations can employ, as an example, HTP's further enabled with one or more SDIO wireless adapters, and appropriate software drivers, and the like.

SFP-based Fast Ethernet switches may be expanded to offer Bluetooth and similar interfaces. These implementations can be adapted and arranged to employ the invention in functional and similar combinations with, for instance, an off-the-shelf SDIO wireless or similar adapter, and appropriate software drivers and the like. In addition, SFP-based Fast Ethernet switches may be utilized also to offer WIMAX interfaces. These implementations can employ the invention in combination with, for example, an off-the-shelf WIMAX wireless SDIO adapter, and appropriate software drivers and the like.

In some other preferred embodiments, the present invention includes the use of read-only memory media in a system of the invention to thereby “manually” switch encoding parameters. Thus, a set of matched media cards inserted into interconnected hot-pluggable modules of the invention can be used to ensure, in some cases manually, that only certain portals of a system can communicate with one another under a particular code or encryption protocol.

The coding software for this aspect of the invention can be contained in any type or types of media as are currently available, or as will be available in the future. The present invention thus includes hot-pluggable-facilitated encryption systems, comprising one or more hot-pluggable modules and a plurality of encoding media and software.

Thus, a set of matched media cards can be used to manually ensure that only terminals having at least one of a set of matched flash media cards can encode/decode certain transmissions. Since the present systems are Hot-Pluggable, the flash media can be switched readily while the systems are functioning, thereby permitting the switching and matching of encoding systems, while prohibiting communication with systems, or portions of systems, that are not intended to send/receive the encoded communications.

In some preferred embodiments of the many combinations, permutations and adaptations of the inventions, Flash Memory information is organized in a standard FAT32 file system. Thus, in these and other similar manifestations and adaptations of the invention, information may be written or edited in any standard PC or other computing system. This advantageous characteristic allows the Flash Memory information to be downloaded off-line in any PC, or in-system through the I2C, by way of in-band provided interfaces, and by similar adaptations. The inventions are therefore adaptable to devices and systems such as Smart Phones, digital cameras, laptops and personal computers so long as they can be configured to support the FAT32 format.

The Hot-Pluggable Transceiver Flash Memory Card Reader/Writer Flash Memory combination may hold, as examples: A) various versions of executable programs, thus providing the advantage of having multiple, variable, and changeable, versions with various features and functionalities, which extend the system capabilities far beyond the built-in system memory capacity; B) customization of each deployed system, each system or system portion having unique behaviors, functions, parameters and characteristics; C) the ability of downloading software applications to the system line cards; D) the ability for applications to be served to an external system, for example, serving applets to a web browser; E) system logs adapted and arranged to, as examples, expand the system logging capacity beyond the built-in system memory capacity, the ability to allow multiple log files per defined filters, for example, per event type or per date type, and then ability to hold operatively interact with provisioning/configuration files that may hold System Configuration and also Security Parameters; and F) system backup covering all the above, and creating an exact image that allows cloning of all or part of the system.

Hot-Pluggable Transceiver Flash Memory Card Reader/Writers of the invention may be adapted and arranged to be a system-specific “valet-parking” key. Indeed, by including in its content all the necessary information (see above), some preferred embodiments of the inventions allow i) Easy cloning and replacement of a failed system, and ii) the creation, cloning, building or re-building of a similar system, or system portions, by changing a few critical parameters. An example of this embodiment is that of creating/cloning a nearly identical system, but with a different IP configuration/address.

As an additional advantage, changes, like the ones mentioned above, may be done on an external system, such as a PC, by editing the flash-memory itself, for example, by editing files residing in a micro-SD memory, or by employing a standard PC or other device equipped with such a memory reader.

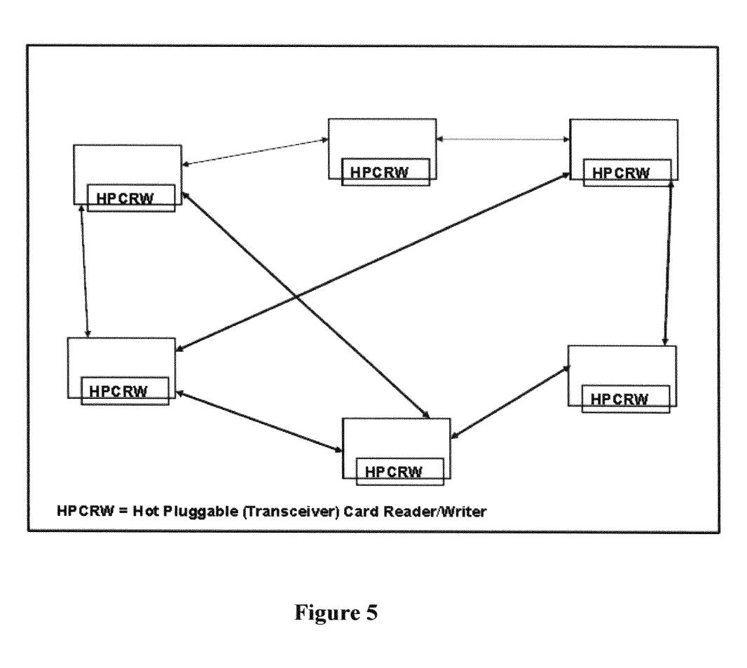

There are many additional examples of implementations of the invention. One example is shown in FIG. 5. As is shown in FIG. 5, each system in the network (has available at least one hot-pluggable transceiver socket) can carry an instance of a Hot-Pluggable Transceiver Flash Memory Card Reader/Writer and a flash memory card. The information in the Flash Memory Card may provide the system unique functionality, may carry its provisioning as well as any security/encryption parameters, necessary to protect the system access.

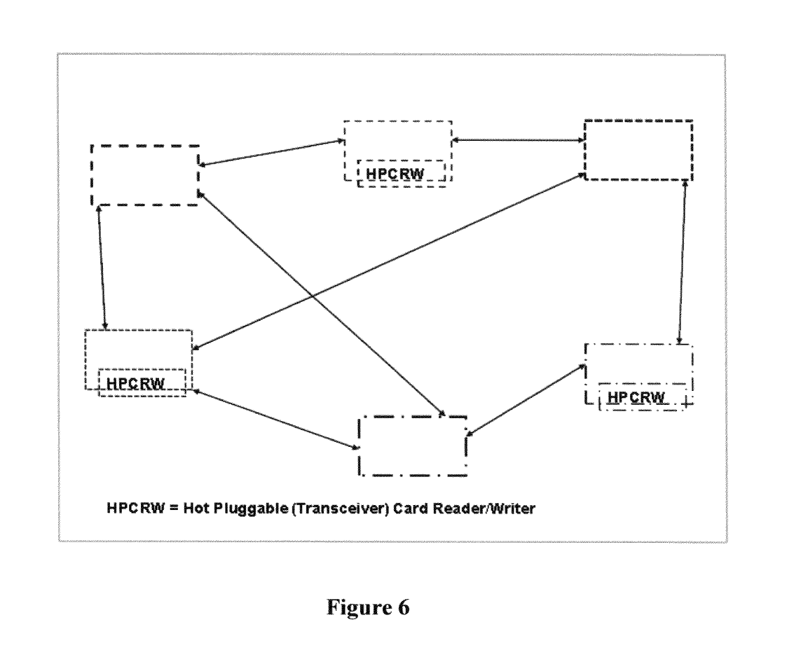

Key examples include also networks or portions of networks. As is shown in FIG. 6, some preferred embodiments of network systems of the invention (that have available Hot-Pluggable Transceiver sockets) carry at least one a Hot-Pluggable Transceiver Flash Memory Card Reader/Writer and a flash memory card. Advantageously, these systems are adapted and arranged to function as servers for themselves and for other systems in the network. The information in the Flash Memory Card can be adapted or arranged to provide each system cluster a unique functionality, and may be adapted and arranged to carry its provisioning, as well as any security/encryption parameters necessary to protect the specific cluster system access (see diagram coloring).

In some preferred embodiments of the invention, the HPT is provided with more than one flashcard slot so that the system can be reconfigured, updated, provided with a different encryption system or disabled as needed. Thus, an entire network, or portions thereof, can be re-configured in many respects. For example, a set of 2 or more transceivers can be linked, sequestered or segregated from another portion of the network by providing the set with matching/coordinated flash memory cards, etc. Among other advantages, this characteristic of the inventions provides additional means and methods for controlling a network or parts of that network. These functions are in addition to those of adding software, reconfiguring the network, adding more storage capacity to the transceiver and adding/reconfiguring the encryption aspects of the transceiver. As yet another similar advantage, the present inventions provide a number of different “Card Matching” functions.

In addition to the devices and the combinations and permutations of the devices described herein, the present inventions therefore include, among others, methods for reconfiguring an optical fiber based communications or data transfer system comprising the step of providing at least one flash memory reader/writer to a Hot-Pluggable Transceiver; methods for reconfiguring the encryption characteristics of an optical-fiber-based communications or data transfer system, comprising the step of providing one or more HPT/Card-related modules that are adapted and arranged to provide various desired functionalities to the system comprising them; and methods for upgrading an optical fiber based communications or data transfer system comprising the step of providing at least one flash memory reader/writer to a Hot-Pluggable Transceiver such that the system in which the HPT/Card module operates is upgraded, and upgradable, by means of substituting or adding one or more flash memory cards to that system.

Specific networks, network portions, methods, devices, and materials are described in this application, but any methods and materials similar or equivalent to those described herein can be used in the practice of the present technology. While embodiments of the technology have been described in some detail and by way of illustrations, such illustration is for purposes of clarity of understanding only, and is not intended to be limiting. Various terms have been used in the description to convey an understanding of the technology. It will be understood that the meaning of these various terms extends to common linguistic or grammatical variations or forms thereof. It will also be understood that when terminology referring to devices or equipment, that these terms or names are provided as contemporary examples, and the technology is not limited by such literal scope. Terminology that is introduced at a later date that may be reasonably understood as a derivative of a contemporary term or designating of a hierarchical subset embraced by a contemporary term will be understood as having been described by the now contemporary terminology.

Moreover, while some theoretical considerations may have been advanced in furtherance of providing an understanding of the technology, the appended claims to the technology are not bound by such theory. Moreover, any one or more features of any embodiment of the technology can be combined with any one or more other features of any other embodiment of the technology, or with any technology described in the patent applications or issued patents that have been incorporated by reference, without departing from the scope of the technology. Still further, it should be understood that the technology is not limited to the embodiments that have been set forth for purposes of exemplification, but is to be defined only by a fair reading of claims appended to the patent application as filed or amended, including the full range of equivalency to which each element thereof is entitled.

What is claimed is:

1. An optical network portion comprising at least one hot-pluggable transceiver,
wherein the at least one hot-pluggable transceiver comprises at least one digital media reader component adapted and arranged for reading from first digital media, and at least one digital media writer component, adapted and arranged for writing to the first digital media
wherein the hot-pluggable transceiver is operationally connected to the network, and wherein the network comprises at least one optical fiber,
such that the at least one hot-pluggable transceiver is adapted and arranged such that the first digital media element can be replaced by a second digital media element while the network portion is operating.

2. The network portion of claim 1, wherein the at least one digital media reader component is combined with the at least one digital media writer component of the hot pluggable transceiver to comprise one or more slots or slot reader/writer adapters in the hot pluggable transceiver,
and wherein the one or more slots are adapted and arranged to operationally connect to one or more of the digital media elements.

3) A method for upgrading, reconfiguring or repurposing an optical fiber based communications or data transfer network or system, the method comprising the steps of
I) providing at least one hot-pluggable transceiver digital memory reader/writer wherein the at least one transceiver comprises at least one digital media reader component adapted and arranged for reading from first digital media, and at least one digital media writer component, adapted and arranged for writing to the first digital media, and wherein the hot-pluggable transceiver is operationally connected to the network, and wherein the network comprises at least one optical fiber, such that the at least one hot-pluggable transceiver is adapted and arranged such that the first digital media element can be replaced by a second digital media element while the network portion is operating, and
II) replacing the first digital media element with a second digital media element, wherein the second digital media element contains one or more of data, instructions and software applications adapted and arranged for effecting the upgrading, reconfiguring or repurposing the network or system.

4. A method for providing additional data, software applications, instructions or encryption capabilities to an optical fiber based network or portion of the network, the method comprising the steps of
I) providing to the network at least one hot-pluggable transceiver digital memory reader/writer wherein the at least one transceiver comprises at least one digital media reader component adapted and arranged for reading from first digital media, and at least one digital media writer component, adapted and arranged for writing to the first digital media, and wherein the hot-pluggable transceiver is operationally connected to the network, and wherein the network comprises at least one optical fiber, such that the at least one hot-pluggable transceiver is adapted and arranged such that the first digital media element can be replaced by a second digital media element while the network portion is operating, and
II) replacing the first digital media element with a second digital media element, wherein the second digital media element contains one or more of the additional data, instructions, software applications and encryption capabilities.
